(19) United States
(12) Patent Application Publication
(10) Pub. No.: US 2026/0249194 A1
(43) Pub. Date: Aug. 27, 2026

(54) MAP TILE GENERATION USING SCAN MAPS FROM CLIENT DEVICES

(71) Applicant: Niantic Spatial, Inc, San Francisco, CA (US)

(72) Inventors: Ben Benfold, Oxford (GB); Bipeng Zhang, Campbell, CA (US); Dorian Mariano Gálvez López, Zaragoza (ES); Daniel Knoblauch, San Francisco, CA (US); John Gibson, Sunnyvale, CA (US)

(21) Appl. No.: 19/062,633

(22) Filed: Feb. 25, 2025

(51) Int. Cl. A63F 13/65; A63F 13/216; A63F 13/35; A63F 13/5378

(52) U.S. Cl. CPC A63F 13/65; A63F 13/216; A63F 13/35; A63F 13/5378

(57) ABSTRACT

The present disclosure describes game server that generates map tiles for a real-world area based on scan maps generated by client devices. To generate the map tiles, the game server stores scan maps from client devices and uses the scan maps to generate map tiles. To generate a map tile for a real-world area, the game server identifies a subset of scan maps that overlap the real-world area and localizes the sensor data across the identified scan maps using control points. In some embodiments, the game server uses an objective function to generate the map tiles based on the sensor data and may apply a gradient descent process to localize the sensor data across scan maps. The game server generates a map tile based on the localized sensor data. It may include meshes, textures, semantic data, and localization data for client device poses.

### BACKGROUND

Online systems may provide virtual reality (VR) or augmented reality (AR) content to users. This VR or AR content may be generated for a user based on the user's location within the physical world. For example, a game server may provide a mobile AR game that presents an augmented version of the real world or characters that appear to be placed within or interact with objects in the real world.

These systems generally require data that describes the physical world to provide content that appears to interact with it. For example, to have a virtual character appear to climb a building, the online system requires data that describes the shape and location of the building. These systems also generally require high fidelity data of the physical world to make the virtual content appear as realistic as possible. Generating this kind of high-quality data for an entire operating area of an online system that provides these VR/AR services requires significant amounts of sensor data describing the areas. Some systems may use sensor scan data that are generated by client devices as users use the VR/AR services provided by the online system to generate the data describing the physical world. However, this sensor data is limited to the areas in which the client device was located, which means that the sensor data from one device cannot be used to describe the full region in which the online system provides services. Furthermore, since different devices use different sensors in different coordinate systems, it is challenging to correlate the sensor data from different devices into cohesive data describing an area, especially where the coordinate systems of each device may drift over time.

### SUMMARY

The present disclosure describes game server that generates map tiles for a real-world area based on scan maps generated by client devices. To generate the map tiles, the game server stores scan maps from client devices, which are sets of environment data such as images, videos, IMU data, magnetometer measurements, and GPS data. These scan maps may be localized to a control point, which is a reference point in the real world. The game server may generate these scan maps during application sessions with client devices, collecting sensor data at regular intervals or distances.

The game server uses the scan maps to generate map tiles. To generate a map tile for a real-world area, the game server identifies a subset of scan maps that overlap the real-world area. For example, the game server may filters out data outside this area and localize the sensor data across the identified scan maps using control points. In some embodiments, the game server uses an objective function to generate the map tiles based on the sensor data and may apply a gradient descent process to localize the sensor data across scan maps.

The game server generates a map tile based on the localized sensor data. A map tile is a 3D map of a real-world area containing data for presenting AR or VR content to client devices. It may include meshes, textures, semantic data, and localization data for client device poses. The map tile may also include virtual content for AR or VR experiences. The game server may generate contiguous map tiles for broader regions and store them for client device requests. When a client device requests content, the game server identifies the corresponding map tile based on the device's sensor data and transmits it to the client device.

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for generating map tiles based on scan maps according to one embodiment.

FIG. 4 is a flowchart of a process for generating map tiles based on scan maps, according to one embodiment.

FIG. 5 illustrates an example map tile generated based on scan maps, in accordance with one embodiment.

FIG. 6 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where generating map tiles based on scan maps is desirable. In addition, the inherent flexibility of computer-based systems allows for a great variety of possible configurations, combinations, and divisions of tasks and functionality between and among the components of the system.

### EXAMPLE LOCATION-BASED PARALLEL REALITY GAME

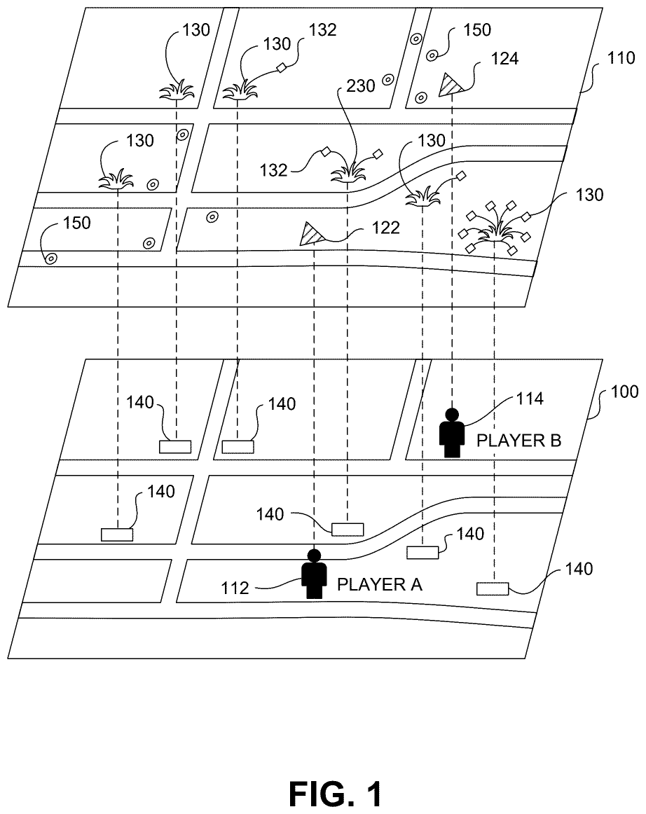

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

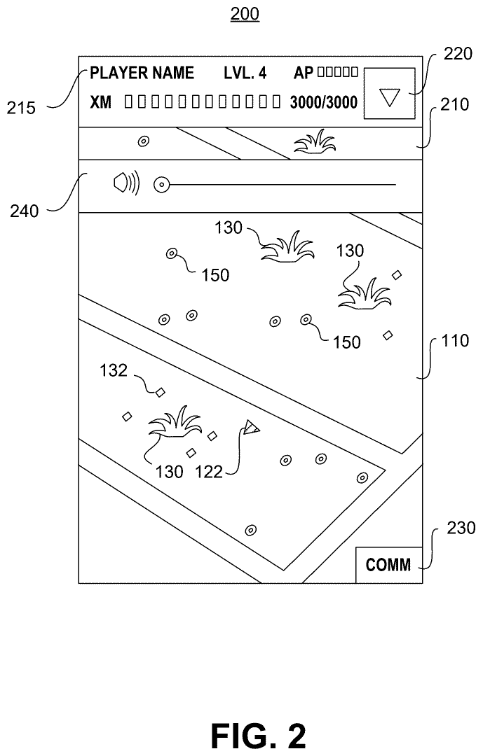

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### EXAMPLE GAMING SYSTEM

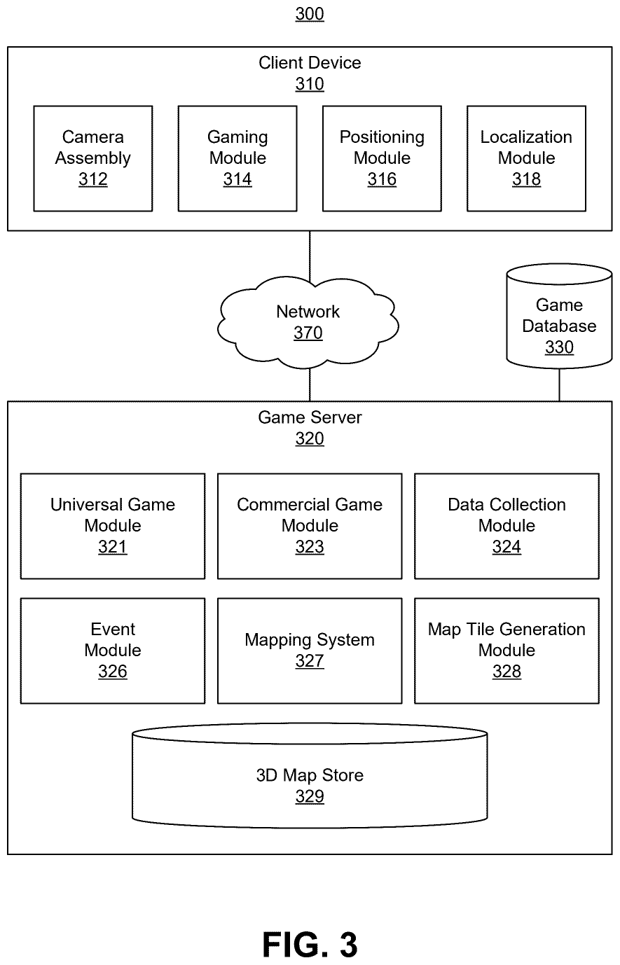

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping system 327, a map tile generation module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 321 hosts an instance of the parallel reality game for a set of players (e.g., all players of the parallel reality game) and acts as the authoritative source for the current status of the parallel reality game for the set of players. As the host, the universal game module 321 generates game content for presentation to players (e.g., via their respective client devices 310). The universal game module 321 may access the game database 330 to retrieve or store game data when hosting the parallel reality game. The universal game module 321 may also receive game data from client devices 310 (e.g., depth information, player input, player position, player actions, landmark information, etc.) and incorporates the game data received into the overall parallel reality game for the entire set of players of the parallel reality game. The universal game module 321 can also manage the delivery of game data to the client device 310 over the network 370. In some embodiments, the universal game module 321 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 321. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 321. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

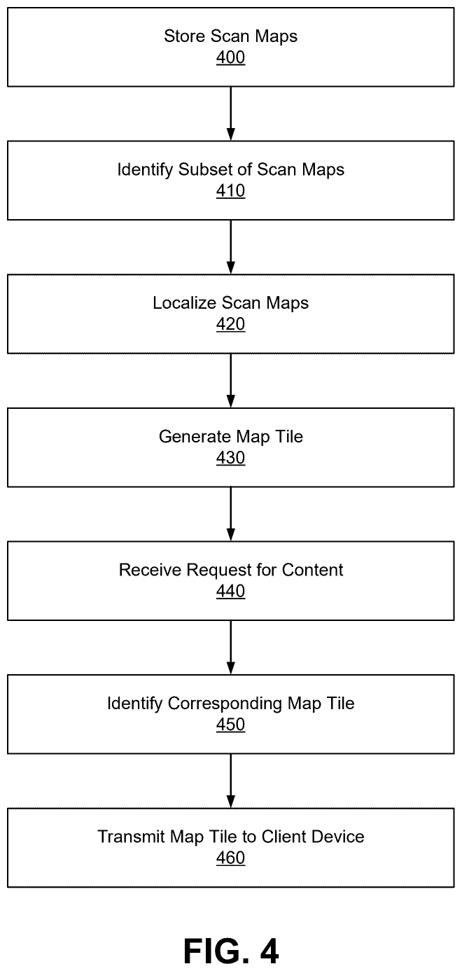

The map tile generation module 328 generates map tiles based on scan maps from the client device 310. The map tile generation module identifies which scan maps to use to generate a map tile and localizes the sensor data within the scan maps to generate the data for each of the tiles. An example process for generating map tiles is described in further detail below with regards to FIG. 4.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### EXAMPLE METHODS

FIG. 4 is a flowchart describing an example method of generating map tiles based on scan maps captured by user computing devices, according to one embodiment. The steps of FIG. 4 are illustrated from the perspective of the game server performing the method. However, some or all of the steps may be performed by other entities or components. In addition, some embodiments may perform the steps in parallel, perform the steps in different orders, or perform different steps.

The game server stores 400 scan maps from client devices. A scan map is a set of environment data describing an environment around a client device at a real-world location. For example, the scan map may include sensor data captured by sensors of the client device. This sensor data may include image or video data captured by a camera, IMU data captured by an inertial measurement unit, magnetometer measurements captured by a magnetometer, or GPS measurements captured by a GPS sensor. The scan map may further include area modeling data that describes a 3D model of the area covered by the scan map. For example, the scan map may include meshes generated based on captured sensor data for the scan map.

The sensor data within a scan is localized to a control point. A control point is a point in the real world that is used as a reference point for a scan map. For example, a scan map's control point may be a center point of the scan map. The game server may localize the sensor data or the map data to the control point by applying an objective function to the sensor data to predict a localization of the sensor data relative to each other and the control point.

The game server may generate a series of scan maps as part of an application session with the client device. For example, the client device may regularly collect sensor data while the client device is in a session with the game server. The game server may generate scan maps based on these collections of sensor data. The client device may collect sensor data over regular time intervals or when the client device has traveled a certain distance.

To generate a map tile, the game server identifies 410 a subset of scan maps to use for generating the map tile. To identify the subset of scan maps, the game server may identify a real-world area over which the map tile will overlay and may identify which scan maps overlap that area. In some embodiments, the game server identifies which scan maps to use by determining which scan maps have control points that fall within that real-world area. The game server may also identify portions of scan maps to use to generate the map tile. For example, the game server may filter out sensor data or modeling data within a scan map that is known to lie outside a real-world area that the map tile covers.

The game server localizes 420 the identified scan maps relative to each other based on sensor data within each scan map. As noted above, each scan map may include sensor data that has been localized to the other data within each scan map. However, the sensor data across scan maps has not necessarily been localized relative to each other. The game server localizes the sensor data across the identified scan maps so that sensor data within the scan maps are all localized relative to each other. In some embodiments, the game server does this localization by using the control points of the scan maps as references and localizing the sensor data of each identified scan map using the control points. The game server also may use an objective function to localize the sensor data within the scan maps. The objective function may represent how well the sensor data within the identified scan maps fits based on pre-determined priors about the maps. For example, the objective function may output a score that represents a likelihood that the respective sensor data were captured at particular poses based on the captured sensor data. In some embodiments, the game server applies a gradient descent approach using the objective function to localize the sensor data among the scan maps. U.S. application Ser. No. 18/301,665, entitled “Estimating Pose for a Client device using a Pose Prior Model” and filed Apr. 17, 2023, includes additional details regarding objective functions used to localize sensor data and is incorporated by reference.

The game server generates 430 a map tile based on the localized sensor data from the identified scan maps. A map tile is a 3D map of a real-world area that contains data for presenting AR or VR content to client devices. For example, the map tile may include a mesh that models the structure of the real-world area, such as buildings or landscape features within the area. The map tile may also include textures to apply to the mesh, semantic data describing the types of structures or features within the real-world area, or localization data for localizing a pose of a client device within the real-world area based on additional sensor data captured by that client device. In some embodiments, the map tile is an S2 cell. Additionally, the map tile includes virtual content to be displayed to a user through a client device within the map tile's corresponding real-world area. For example, the map tile may include AR or VR content to be displayed to a user based on the client device's pose within the real-world area.

In some embodiments, the game server generates a map tile by computing the relative positions of scan maps and aligning the relative positions with world geographic coordinates. For example, the game server may apply an objective function to the scan maps to compute a relative position of each scan map to each other. The game server may compute these relative positions for all scan maps, for a subset of scan maps within a broader geographic region, or the identified scan maps for a set of map tiles. When the relative positions of the scan maps have been determined, the game server aligns the scan maps with a real-world geographic coordinate system. The game server may align the scan maps with the real-world geographic coordinate system by applying another objective function to the set of scan maps whose relative positions have been determined and to real-world geographic coordinate data. In some embodiments, the game server applies a single objective function to determine the relative positions of the scan maps and to align the scan maps with the real-world geographic coordinate system in a single step.

The game server may generate a set of map tiles for a broader geographic region by generating map tiles for contiguous areas within the real-world. The game server may store these map tiles and provide them to client devices when requested. For example, the game server may receive 440 a request for content from a client device. The request may include sensor data describing the pose of the client device, such as GPS data or IMU data. The game server identifies 450 a corresponding map tile based on the request (e.g., by identifying a corresponding area of the real world in which the client device is most likely located) and transmits 460 the identified map tile to the client device.

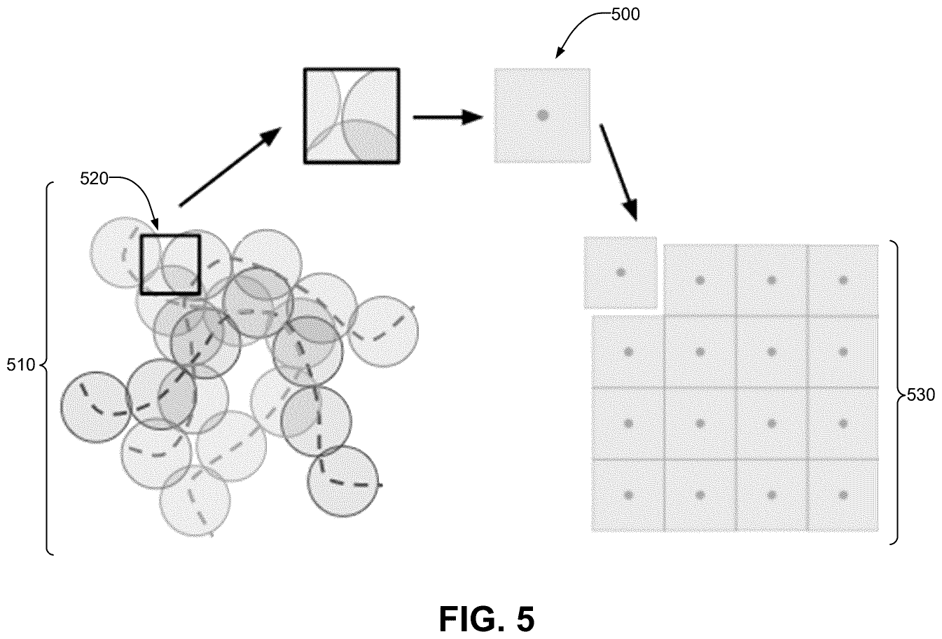

FIG. 5 illustrates an example map tile 500 generated based on scan maps 510, in accordance with some embodiments. The illustrated scan maps 510 are scan maps generated as part of three different application sessions of client devices with the game server. Each of the scan maps includes sensor data for an area around where the client device was located and describes the environment around the client device at that time. The game server generates the map tile 500 based on a subset 520 of the sensor data in the scan maps 510. The game server may generate a set 530 of contiguous map tiles based on the sensor data within the scan maps 510.

### EXAMPLE COMPUTING SYSTEM

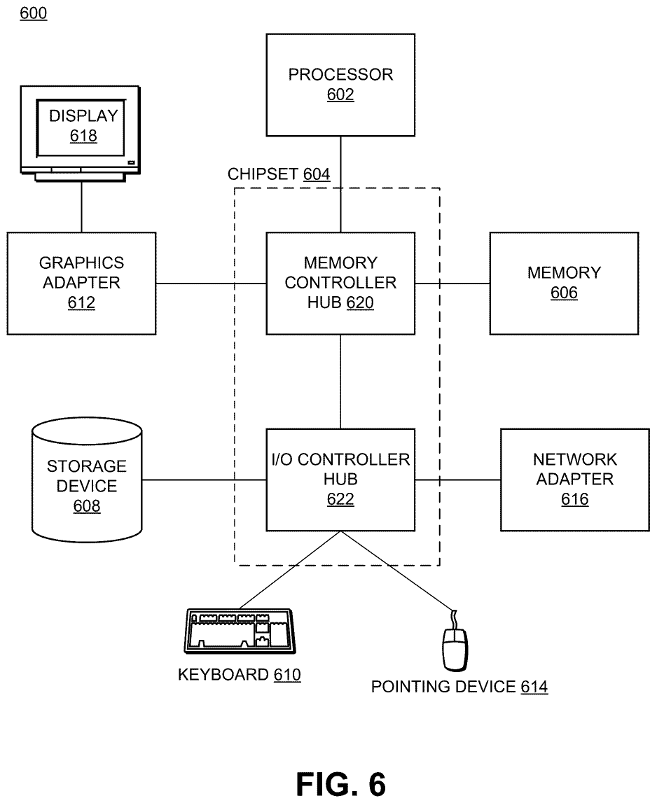

FIG. 6 is a block diagram of an example computer 600 suitable for use as a client device 310 or game server 320. The example computer 600 includes at least one processor 602 coupled to a chipset 604. References to a processor (or any other component of the computer 600) should be understood to refer to any one such component or combination of such components working cooperatively to provide the described functionality. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 370.

The types of computers used by the entities of FIG. 3 can vary depending upon the embodiment and the processing power required by the entity. For example, the game server 320 might include multiple blade servers working together to provide the functionality described. Furthermore, the computers can lack some of the components described above, such as keyboards 610, graphics adapters 612, and displays 618.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
storing a plurality of scan maps, wherein each scan map comprises environment data describing an environment around a computing device at a point in time;
generating a plurality of map tiles for a geographic region based on the plurality of scan maps, wherein generating a map tile of the plurality of map tiles comprises:
identifying a subset of the plurality of scan maps for generating a map tile for an area in the real world;
localizing the identified subset of scan maps relative to each other based on the environment data in each of the identified subset of scan maps;
generating the map tile for the area in the real world based on the localized subset of scan maps, wherein the generated map models the corresponding area in the real world; and
storing the map tile in a map tile database;
receiving a request for virtual content from a client device, wherein the request for virtual content describes a pose of the client device;
identifying a map tile of the plurality of map tiles based on the pose in the request for virtual content and the corresponding areas in the real world; and
transmitting the identified map tile to the client device.

2. The computer-implemented method of claim 1, wherein the plurality of scan maps each comprise a control point and the environment data of each scan map is localized relative to the corresponding control point.

3. The computer-implemented method of claim 1, wherein the environment data in the plurality of scan maps comprises sensor data captured by sensors of the computing devices.

4. The computer-implemented method of claim 1, wherein the environment data in the plurality of scan maps comprises 3D mesh data describing the environments around the computing devices.

5. The computer-implemented method of claim 1, wherein storing the plurality of scan maps comprises:
establishing an application session with a client device; and
receiving the scan map from the client device as part of the application session.

6. The computer-implemented method of claim 1, wherein generating a map tile of the plurality of map tiles comprises:
generating a 3D mesh for the area in the real world based on the localized subset of scan maps.

7. The computer-implemented method of claim 1, wherein generating a map tile of the plurality of map tiles comprises:
generating one of texture data, localization data, or segmentation data for the area of the real world.

8. The computer-implemented method of claim 1, wherein generating a map tile of the plurality of map tiles comprises:
generating virtual-reality content or augmented-reality content for display to a user through a computing device.

9. The computer-implemented method of claim 1, wherein localizing the identified subset of scan maps comprises:
applying an objective function to the environment data in the identified subset of scan maps.

10. The computer-implemented method of claim 9, wherein applying the objective function comprises:
applying the objective function to the environment data using a gradient descent process.

11. A non-transitory computer-readable medium storing instructions that, when executed by a computer system, cause the computer system to perform operations comprising:
storing a plurality of scan maps, wherein each scan map comprises environment data describing an environment around a computing device at a point in time;
generating a plurality of map tiles for a geographic region based on the plurality of scan maps, wherein generating a map tile of the plurality of map tiles comprises:
identifying a subset of the plurality of scan maps for generating a map tile for an area in the real world;
localizing the identified subset of scan maps relative to each other based on the environment data in each of the identified subset of scan maps;
generating the map tile for the area in the real world based on the localized subset of scan maps, wherein the generated map models the corresponding area in the real world; and
storing the map tile in a map tile database;
receiving a request for virtual content from a client device, wherein the request for virtual content describes a pose of the client device;
identifying a map tile of the plurality of map tiles based on the pose in the request for virtual content and the corresponding areas in the real world; and
transmitting the identified map tile to the client device.

12. The computer-readable medium of claim 11, wherein the plurality of scan maps each comprise a control point and the environment data of each scan map is localized relative to the corresponding control point.

13. The computer-readable medium of claim 11, wherein the environment data in the plurality of scan maps comprises sensor data captured by sensors of the computing devices.

14. The computer-readable medium of claim 11, wherein the environment data in the plurality of scan maps comprises 3D mesh data describing the environments around the computing devices.

15. The computer-readable medium of claim 11, wherein storing the plurality of scan maps comprises:
establishing an application session with a client device; and
receiving the scan map from the client device as part of the application session.

16. The computer-readable medium of claim 11, wherein generating a map tile of the plurality of map tiles comprises:
generating a 3D mesh for the area in the real world based on the localized subset of scan maps.

17. The computer-readable medium of claim 11, wherein generating a map tile of the plurality of map tiles comprises:
generating one of texture data, localization data, or segmentation data for the area of the real world.

18. The computer-readable medium of claim 11, wherein generating a map tile of the plurality of map tiles comprises:
generating virtual-reality content or augmented-reality content for display to a user through a computing device.

19. The computer-readable medium of claim 11, wherein localizing the identified subset of scan maps comprises:
applying an objective function to the environment data in the identified subset of scan maps.

20. The computer-readable medium of claim 19, wherein applying the objective function comprises:
applying the objective function to the environment data using a gradient descent process.
